(19) United States
(12) Patent Application Publication
(10) Pub. No.: US 2011/0039694 A1
(43) Pub. Date: Feb. 17, 2011

(54) POLYMER BASED SEED COATING

(75) Inventors: Fred C. Rosa, Wake Forest, NC (US); William S. Hanson, Wake Forest, NC (US); Jackie S. Mote, Wylie, TX (US)

Correspondence Address: BAYER CROPSCIENCE LP, Patent Department, 2 T .W. ALEXANDER DRIVE, RESEARCH TRIANGLE PARK, NC, 27709, US

(73) Assignee: BAYER CROPSCIENCE LP, RESEARCH TRIANGLE PARK, NC (US)

(21) Appl. No.: 12/910,345

(22) Filed: Oct. 22, 2010

Related U.S. Application Data
(62) Division of application No. 11/365,123, filed on Mar. 1, 2006.

(51) Int. Cl. A01N 25/26; A01N 43/78; A01P 3/00; A01P 7/04; A01C 1/06

(52) U.S. Cl. 504/100; 47/57.6

(57) ABSTRACT

A seed coated with a composition including a binder, a wax, one or more stabilizers, and an optional colorant.

### CROSS REFERENCE TO RELATED APPLICATIONS

This application is a divisional application of U.S. patent application Ser. No. 11/365,123, filed Mar. 1, 2006, the disclosure of which is herein incorporated by reference in its entirety.

### BACKGROUND OF THE INVENTION

This invention relates to a seed coating to facilitate the binding of an bioactive ingredient, such as an insecticide or fungicide, to seed and allowing for the flowability of the coated seed during planting.

The control of insects and related arthropods is of extreme importance to the agricultural industry. Every year, these pests destroy an estimated 15% of agricultural crops in the United States and even more than that in developing countries. Some of this damage occurs in the soil when plant pathogens, insects and other such soil borne pests attack the seed after planting. Much of the rest of the damage is caused by rootworms; plant pathogens that feed upon or otherwise damage the plant roots; and by cutworms, European corn borers, and other pests that feed upon or damage the above ground parts of the plant. General descriptions of the type and mechanisms of attack of pests on agricultural crops are provided by, for example, Metcalf, in Destructive and Useful Insects, (1962); and Agrios, in Plant Pathology, 3rd Ed., Academic Press (1988).

The period during germination of the seed, sprouting and initial growth of the plant is particularly critical because the roots and shoots of the growing plant are small and even a small amount of damage can kill the entire plant. Moreover, some natural plant defenses are not fully developed at this stage and the plant is vulnerable to attack. Not surprisingly, the control of pests that attack the seed and the above ground plant parts during this early stage of plant growth is a well developed area of agriculture.

Currently, the control of pests that attack post emergent crops primarily involves the application of synthetic organic pesticides to the soil, or to the growing plants by foliar spraying. Because of concern about the impact of chemical pesticides on public health and the environment, there has been much effort to reduce the amount of chemical pesticides that are used.

Insecticides such as imidacloprid and clothianidin; and the like, are very effective against certain above ground plant pests when applied at the proper time and with proper procedures. Appropriate pesticides may be applied at the time of planting as surface bands, “T”-bands, or in-furrow, but these applications require the additional operation of applying the pesticide at the same time as the seeds are being sown. This complicates the planting operation and the additional equipment required for pesticide application is costly to purchase and requires maintenance and attention during use. Moreover, care must be taken to incorporate the pesticides properly into the topmost soil layer for optimal activity.

The control of pests by applying insecticides directly to plant seed is well known. For example, U.S. Pat. No. 5,696,144 discloses that the European corn borer caused less feeding damage to corn plants grown from seed treated with a 1-arylpyrazole compound at a rate of 500 g per quintal of seed than control plants grown from untreated seed. In addition, U.S. Pat. No. 5,876,739 to Turnblad et al. (and its parent, U.S. Pat. No. 5,849,320) disclose a method for controlling soil-borne insects which involves treating seeds with a coating containing one or more polymeric binders and an insecticide. This reference provides a list of insecticides that it identifies as candidates for use in this coating and also names a number of potential target insects. However, while the U.S. Pat. No. 5,876,739 patent states that treating corn seed with a coating containing a particular insecticide protects corn roots from damage by the corn rootworm, it does not indicate or otherwise suggest that the coating while helping to bind the insecticide to the seed also provides an ease in dispersion of the seed in order to help maximize the economic potential for the farmer.

The use of talc as a lubricating agent is well known in the seed industry. See for example Agronomy Bulletin by Agrilance (Apr. 9, 2004) where various insecticides are offered with a talc-based formulation. Graphite is an alternative lubricant but many times it is prohibited for use in certain planting equipment.

Seeds treated with insecticide can cause plant-spacing problems because the seeds coated just with the insecticide can have a pebbly, rough surface compared to smooth, untreated kernels. Most planters are designed to handle smooth surface seed. Adding talc for vacuum planters or graphite for seed planted through finger pickup planters has been one solution.

### SUMMARY OF THE INVENTION

Farmers need to maximize their yield and if seeds are not lubricated properly then not enough seeds are planted per acre. Typical in the industry a goal of approximately 30,000 seeds per acre is considered ideal. Seeds that have been coated with one or more bioactive ingredients such as an insecticide, fungicide, or a safener can be lubricated to achieve this potential planting goal.

### DETAILED DESCRIPTION OF THE INVENTION

Seeds can be batch or continuous feed treated with a polymer coating to facilitate plantability. The polymer coating is comprised of a binder, a wax and a pigment, and one or more stabilizers in an amount effective to stabilize the suspension.

The binder can be a polymer selected from the group consisting of vinyl acetate-ethylene copolymer, vinyl acetate homopolymer, vinyl acetate-acrylic copolymer, vinylacrylic, acrylic, ethylene-vinyl chloride, vinyl ether maleic anhydride, or butadiene styrene. Other similar polymers can be used.

The wax can be natural wax (beeswax or lanolin), vegetable wax (Carnauba), mineral wax (montan or paraffin), synthetic wax (polyethylene (polar or nonpolar), polypropylene, Fischer-Tropsch, or polybutene), or another lubricant such as polytetrafluoroethylene. There are many other waxes that can be used.

The stabilizers can be one or more of the following type of ingredients: a suspending aid, a humectant and a biocide. The suspending aid can be attapulgite clay, bentonite clay, smectite clay, hectorite clay, cellulosic, xanthum gum, or guar gum.

A humectant can be included as a stabilizer to promote the retention of water, an element that can be crucial to the viability of the seed. A typical humectant that is commonly used is propylene glycol. Many other humectants will work.

Another stabilizer that can be added is a biocide. A common biocide found in the market is 1,2-benzisothiazolin-3-one, which can be obtained from Avecia, Inc. as Proxel GXL as a solution in sodium hydroxide and dipropylene glycol.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. As one skilled in the art can appreciate, the exact amount of coating will vary depending on the size of the seed to be coated. Unless otherwise noted, all temperatures are degrees Celsius and all parts and percentages are parts by weight and percentages by weight, respectively.

The amount of wax in the coating will be in the range of about 12.5% to 30% of the total weight of the binder, preferably at 15%. The wax of the preferred embodiment is a polyolefin based micronized wax powder, known in the art as MICHEM® Wax 437 (obtained from Michelman). The pigment will be in the range of 0 to 15% of the weight of the binder and in the preferred embodiment is a titanium dioxide coated mica (Luster White FR2P from Stochem) at 15% of the total weight of the binder. The amount of polyolefin polymer will typically be 20% by weight of the binder and preferably will be a carboxylated styrene-butadiene dispersion (Styrofan® NX 6650 X from BASF at 20% of the total weight of the binder).

One or more stabilizers can be added to the coating. A suspending aid can be added in the range of 0.50% to 1.00% of the weight of the binder. In the preferred embodiment, the suspending aid was Van Gel B (obtained from R.T. Vanderbilt Company, Inc. as a 5% solution) at 1.0% of the total weight of the binder. The humectant can vary from 2.4% to 4.9% of the total weight of the binder and in the preferred embodiment the humectant was propylene glycol at 4.9% of the total weight of the binder. A biocide can be added in the range of 0.10% to 0.20% of the total weight of the binder and in the preferred embodiment was Proxel GXL at 0.20% (obtained from Avecia, Inc. as a solution in sodium hydroxide and dipropylene glycol). The binder is prepared in a water solution, and in the preferred embodiment the amount of water was approximately at 40%. In the preferred embodiment Rhodoline 111 (obtained from Rhodia Novecare) was also added at 2% of the total weight of the binder and used as an anionic dispersant and also as a viscosity stabilizer for extended shelf life. Also included in the preferred embodiment was Rhodafac RE610, a phoshatized ethoxylated alkylphenol (a product of Rhone Poulenc) which is used as a surfactant at 1.5% of the total weight of the binder.

In the preferred embodiment a batch of the binder was prepared as follows. Twenty-eight pounds of the Van Gel B (1.0% by weight) was added to 1,109.9 pounds of water (39.6% by weight) and the mixture was blended for 45 minutes. To this solution was added 3.4 pounds of AF-10 (0.122% by weight), 42 pounds of RE-610 (1.5%), and 14 pounds of TR16607 (0.5%) and 420 pounds of Michem 437 (15%) and the solution is then mixed for 20 minutes. Then 560.17 pounds of Styrofan NX 6650 (20%) and 420 pounds of Luster White FR2P (15%) was then mixed for an additional 20 minutes. Finally additional stabilizers were added including 2.8 pounds of Kelzan (0.1%), 137.24 pounds of propylene glycol (4.9%) and 56 pounds of Rhodoline 111 (2.0%) and 6.999 pounds of Proxel GXL (0.2499%) was added to the mixture.

The seed can be coated in a batch treatment process where in the seed is introduced to the batch treatment tank and one or more bioactive ingredients (such as Bayer's Poncho 600 in an undiluted solution, as well as other insecticides, fungicides and/or safener) are then added. To the seed coated with the bioactive ingredient is then added the liquid binder. A colorant can then be added to meet various regulatory requirements for signifying that the seed has been treated. Alternatively a continuous treatment process can be used to coat the seed wherein a water slurry is prepared containing one or more bioactive ingredients, the liquid coating, and, if needed, a colorant to color the seed. Then the seed is introduced into the slurry. In all cases the seed must be allowed a period of time to dry. Typically the seed is spun in a bowl for a period of at least 15 seconds to allow for drying. Different time periods may be needed to allow for variability in drying conditions due to weather or different seed sizes.

What is claimed is:

1. A seed coated with a coating composition comprising:
a binder,
a wax,
one or more stabilizers, and
an optional colorant.

2. The seed according to claim 1, wherein:
the binder is selected from the group consisting of vinyl acetate-ethylene copolymer, vinyl acetate homopolymer, vinyl acetate-acrylic copolymer, vinylacrylic, acrylic, ethylene-vinyl chloride, vinyl ether maleic anhydride, and butadiene styrene;
the wax is selected from the group consisting of natural wax, vegetable wax, mineral wax, synthetic wax, and other lubricant; and
the one or more stabilizers is selected from the group consisting of a suspending aid, a humectant, and a biocide.

3. A seed according to claim 1, wherein the binder comprises a carboxylated styrene-butadiene dispersion.

4. A seed according to claim 1, wherein the wax is selected from the group consisting of beeswax, lanolin, carnauba, montan, paraffin, polar polyethylene, nonpolar polyethylene, micronized polyethylene, polypropylene, Fischer-Tropsch, polybutene, and polytetrafluoroethylene.

5. A seed according to claim 1, wherein the wax comprises a polyolefin based micronized wax powder.

6. A seed according to claim 1, wherein the one or more stabilizers is selected from the group consisting of attapulgite clay, bentonite clay, smectite clay, hectorite clay, cellulosic, xanthum gum, guar gum, propylene glycol, and 1,2-benzisothiazolin-3-one.

7. A seed according to claim 1, wherein the coating composition comprises the colorant.

8. A seed according to claim 7, wherein the colorant comprises pigment coated mica.

9. A seed according to claim 7, wherein the colorant comprises titanium dioxide coated mica.

10. A seed according to claim 1, wherein the seed is selected from the group consisting of corn, wheat, soybean, canola, sunflower, alfalfa, edible beans, grains sorghum, turf, forage grass, and peas.

11. A seed according to claim 1, wherein the coating composition comprises 12.5 to 30 wt % of the wax, based on the total weight of the binder.

12. A seed according to claim 1, wherein the coating composition comprises
0.50 to 1 wt % of a suspending aid;
2.4 to 4.9 wt % of a humectant; and
0.10 to 0.20 wt % of a biocide, based on the total weight of the binder.

13. A seed according to claim 1, wherein the coating composition comprises an anionic dispersant.

14. A seed according to claim 1, wherein the coating composition comprises a surfactant.

15. A seed according to claim 1, wherein the coating composition comprises at least one bioactive ingredient selected from the group consisting of a fungicide, an insecticide, clothianidin, and a safener.

16. A seed according to claim 1, wherein the coating composition facilitates the binding of a bioactive ingredient to the seed and allows for the flowability of the coated seed during planting.

17. A method of allowing for the flowability of a seed during planting, the method comprising:
coating a seed with a coating composition comprising
a binder,
a wax,
a stabilizer, and
an optional colorant.

18. A method according to claim 17, wherein the binder comprises a carboxylated styrene-butadiene dispersion.

19. A method for coating a seed with a bioactive ingredient, the method comprising
applying at least one bioactive ingredient to the seed; and
applying a coating composition to the seed coated with the bioactive ingredient, the coating composition comprising a binder, a wax, a stabilizer, and an optional colorant.

20. A method according to claim 19, wherein the binder comprises a carboxylated styrene-butadiene dispersion.
